(19) United States
(12) Patent Application Publication
(10) Pub. No.: US 2003/0072008 A1
(43) Pub. Date: Apr. 17, 2003

(54) High filtering precision optical signal interleaver

(75) Inventors: Chen-Bin Huang, Hsin-Chu City (TW); Chieh Hu, Taichung (TW)

Correspondence Address: BACON & THOMAS, PLLC, 625 SLATERS LANE, FOURTH FLOOR, ALEXANDRIA, VA, 22314

(73) Assignee: Industrial Technology Research, Hsin-Chu Hsien (TW)

(21) Appl. No.: 10/022,409

(22) Filed: Dec. 20, 2001

(30) Foreign Application Priority Data
Oct. 15, 2001 (TW) 090125345

(51) Int. Cl. G02B 5/30; G02B 27/28; G01B 11/02

(52) U.S. Cl. 356/498; 359/484; 359/497

(57) ABSTRACT

This invention mainly provides a structure of high filtering precision optical signal interleaver. Herein the birefringent crystal is designed to lead the incident light having a suitable phase-delay and multi-pass to achieve a flattened filtering spectrum and to reduce the filtering spectrum error caused by unmatched component crystal length. Moreover, this invention will eliminate the element number and shorten the element length concurrently.

### BACKGROUND OF INVENTION

1. Field of Invention

This invention mainly provides a structure of high filtering precision optical signal interleaver. According to the application of the fiber communication, it requires both accessing and retrieving functions for optical-signal with specified wavelength, especially it is useful in wide-band optical DWDM communication networks.

2. Description of The Prior Art

Internet generally needs to handle a huge amount of communication and desires to expand its transmitting capability as required, and then the Internet equipment must have more wide-band channels to process and/or to forward the video and audio messages. Herein the fiber communication owns a lot of characteristics such as low loss, high capability, high transmitting rate, no EM interference, high security, light mass and small volume. Therefore, the fiber communication is widely developed and tremendously applied to the long-distance communication, local network, cable TV system, client loop-circuit, Internet, computer network, etc. Both Wavelength Division Multiplexing (WDM) and Dense Wavelength Division Multiplexing (DWDM) are extremely used to expand the total transmitting capability of the nowaday fiber communication architecture. DWDM can be used to collect lots of optical signals of different wavelengthls and to transmit them through a single-core completely. Wavelengths add/drop are usually accomplished by using optic thin-film filters, but it is not easy to reduce the channel width and the aging effect is serious under the high power operation for these optic thin-film filters.

For instance, patent U.S. Pat. No. 6,169,626 shows the periodical signal-separator structure, which is constructed by using a free-space layer Fabry-Perot and a prism splitter. When the glass material temperature expansion of this free-space layer Fabry-Perot is small, the device will have good temperature stability. Unfortunately, this designed structure needs more components and that will make its volume large. Patents as U.S. Pat. No. 6,252,711, U.S. Pat. No. 6,215,923, U.S. Pat. No. 6,212,313 and U.S. Pat. No. 5,694,233, all of them adopt the periodical signal-separator structure by using optical birefringence. However, U.S. Pat. No. 6,252,711 needs too many crystals, lowering its economy benefit, and U.S. Pat. No. 6,215,923, U.S. Pat. No. 6,212,313 and U.S. Pat. No. 5,694,233 use multiple birefringent crystals to flatten its spectrum simultaneously, but the unmatched length between those multiple birefringent crystals leading to an unwanted spectra error.

A birefringent filter, which is shown in FIG. 1, comprises a first birefringent crystal 1 with L1 length, a second birefringent crystal 2 with L2 length and an analyzer 3. Wherein the optic axis of the first birefringent crystal 1 and second birefringent crystal 2, with angles θ1 and θ2 respectively to X axis, is perpendicular to the orientation of incident light (Z axis). After the incident light goes through the first birefringent crystal 1 and second birefringent crystal 2, the pass-band width will be flattened as soon as it pass by the analyzer 3, fulfilling the condition L2=2L1 and the suitable design conditions. The filtering spectrum is shown as FIG. 2. However, the birefringent crystal length should have an uncertainty during the manufacture process. In FIG. 3, the filtering spectrum with unmatched length, L2=2L1+1 um is presented. We can find out the difference comparing to FIG. 2, and recognize the central part is not flattened and its inter-channel cross-talk level is 30 dB lower. It means the unmatched length during crystal processing causes serious spectrum error.

### SUMMARY OF THE INVENTION

Conclusively, the main purpose of this invention can lead to solve the above-mentioned defects. To overcome those aforesaid problems, this invention provides a structure of high filtering precision optical signal interleaver to make the same interval between different wavelengths (such as ITU wavelength). Whenever the wavelength especially consists of intercross optical signals (such as odd and even ITU wavelengths), this invented birefringent crystal will merge or separate the signal sending into a fiber port. Therefore, the current network can simply adopt this invention to expand its transmitting capability by exchanging the wavelength interval of the light source. Herein the birefringent crystal is designed to lead the incident light having a suitable phase-delay and multi-pass to achieve a flattened filtering spectrum and to solve the filtering spectrum error caused by unmatched component crystal length. Moreover, this invention will eliminate the element number and shorten the element length concurrently.

In order to achieve the aforesaid goal, this invention provides a high filtering precision optical signal interleaver, which comprises: the first polarization spiltter, a birefringent filter, a polarization rotating mechanism, the second polarization splitter, the third polarization splitter and an optic angle refractor. Whenever an incident light (optical signal own all related wavelength) goes through birefringent filter, it will form orthogonal polarization between odd wavelength and even wavelength. Herein the optic forward path is determined as the incident light passing in front of the birefringent filter and horizontally through the birefringent filter. After reflection twice inside the first right angle reflector, then it goes through the first polarization control crystal and the birefringent filter in the reverse parallel direction to the original incident light path. That light beam will reflect twice inside the second right-angle reflector to form a light beam in the same direction to the original incident light path, and then goes through the second polarization control crystal and the birefringent filter. Since the birefringent filter will lead the incident light beam to acquire a suitable phase-delay with multi-pass design, it can gain a flattened filtering spectrum and reduce the filtering spectrum error of unmatched component crystal length. Moreover, this invention will eliminate the element number and shorten the element length simultaneously.

### BRIEF DESCRIPTION OF THE DRAWINGS

FIG. 1: Schematic drawing of a known birefringent filter.

FIG. 2: An ideal filtering spectrum.

FIG. 3: A filtering spectrum error caused by the unmatched length.

FIG. 4: Functional schematic of this invented birefringent filter.

FIG. 5a:Configuration of this invented birefringent filter (Example 1).

FIG. 5b:Configuration of this invented temperature stable birefringent filter (Example 2).

FIG. 6a:The X-Z planar schematic drawing of this invented high filtering precision optical signal interleaver.

FIG. 6b:The Y-Z planar schematic drawing of this invented high filtering precision optical signal interleaver.

FIGS. 7a ˜7c: Schematic drawing of optical signal polarization state that is corresponding to the separated wave of each element in FIG. 6.

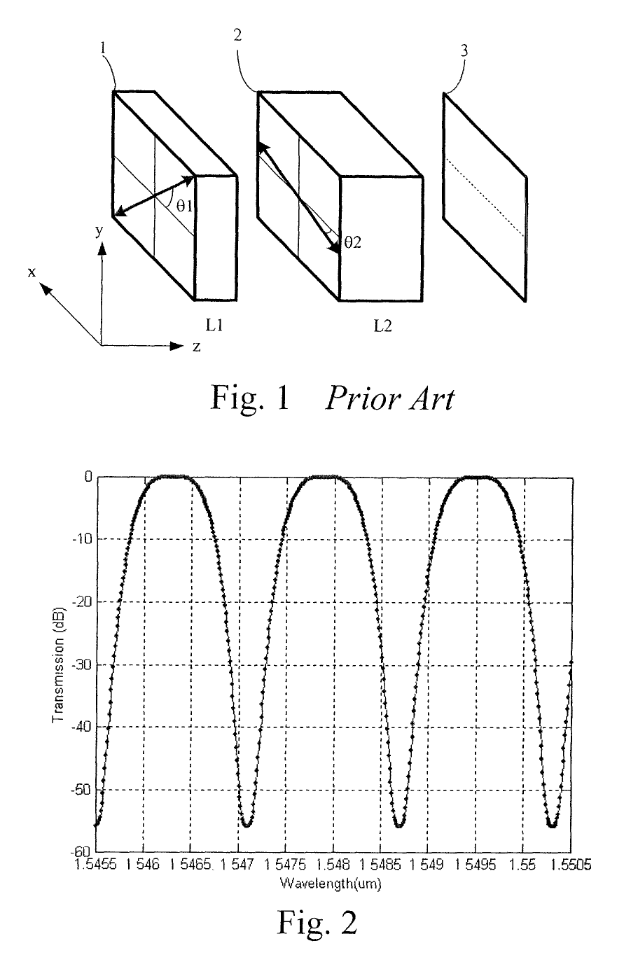

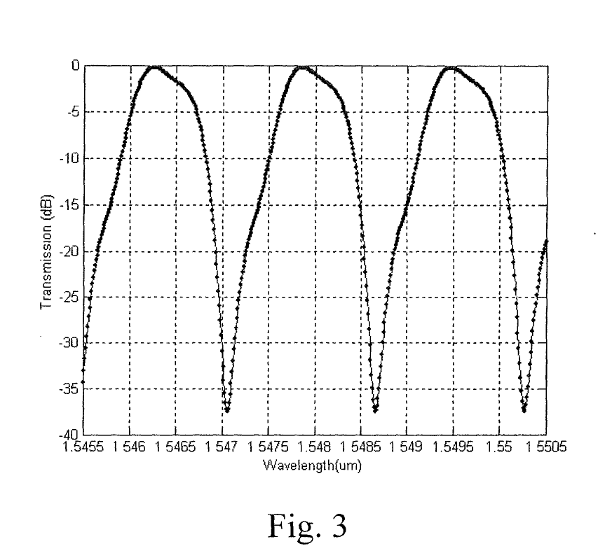

### DETAILED DESCRIPTION OF THE PREFERRED EMBODIMENTS

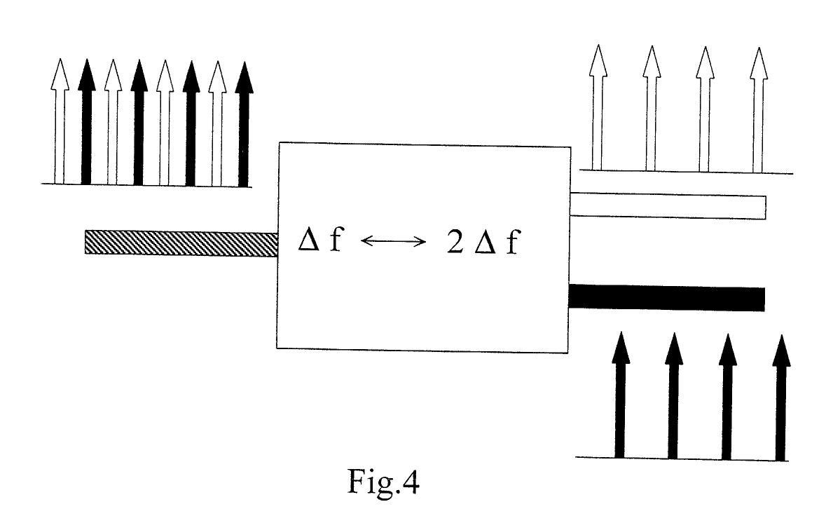

This invention mainly provides a structure of high filtering precision optical signal interleaver, comprising of: a first polarization splitter 20a, a birefringent filter 10, a polarization rotation mechanism 40, a second polarization splitter 20b, a third polarization splitter 20c and an optic angle refractor 50. Herein the birefringent crystal 11 is designed to lead the incident light having a suitable phase-delay and multi-pass to achieve a flattened filtering spectrum and to reduce the filtering spectrum error caused by unmatched component crystal length. Moreover, this invention will eliminates the element number and shorten the element length concurrently. According to the functional schematic drawing of this invented birefringent filter is shown in FIG. 4, the light beam passing through the birefringent crystal 11 will cause an orthogonal polarization between odd wavelength (λ1, λ3, λ5, . . . ) and even wavelength (λ2, λ4, λ6, . . . ) due to the phase-delay of different wavelength, as soon as an incident light beam 110 owns whole wavelength (λ1, λ2, λ3, λ4, . . . ) and its polarization angle is 45 degree to the optic axis of the birefringent crystal 11. Herein only a birefringent crystal 11 is needed to lead the incident light having a suitable phase-delay with multi-pass design, which is completely satisfied with pass-band L2=2L1 condition, to achieve a flattened filtering spectrum and to eliminate the filtering spectrum error caused by unmatched component crystal length (L2≠2L1).

### FIRST EXAMPLE

### Birefringent Filter Configuration

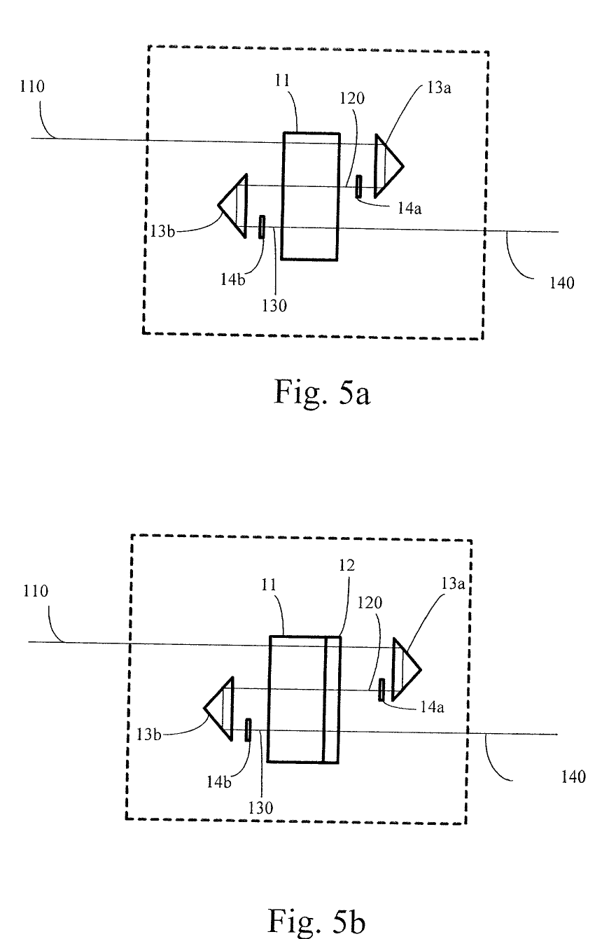

According to the configuration of this invented birefringent filter is shown in FIG. 5a, the optic forward path is determined as the horizontal incident light beam 110 (λ1, λ2, λ3, λ4 . . . ) with a polarization angle is 45 degree to the optic axis of the birefringent crystal 11, and then passes in front of the birefringent crystal 11 and goes normally through the birefringent crystal 11. Furthermore, the light beam passing through the birefringent crystal 11 will cause an orthogonal polarization between the odd wavelength (λ1, λ3, λ5, . . . ) and the even wavelength (λ2, λ4, λ6, . . . ) is due to the phase-delay of different wavelength. The orthogonal polarization light beam now goes into first right-angle reflector 13a, it goes through the first polarization control crystal 14a to form first reflect light beam 120 (reverse orientation to original incident light) after reflection twice insider the first right-angle reflector 13a. Herein all wave polarization will be rotated with an angle θ2 being related to the optic-axis as soon as the light beam went through the first polarization control crystal 14a. Recursively adopts right angleangle reflector to exchange the light-beam forwarding path, that first reflect light beam 120 will go through birefringent crystal 11, and then make that first reflect light beam 120 reflect twice inside the second right angle reflector 13b to form a second reflect light beam 130 (same orientation to original incident light) after it pass through the second polarization control crystal 14b. After all that second reflect light beam 130 will normally pass through the birefringent crystal 11 birefringent crystal to form a flattened filtering light beam 140. Herein the orthogonal polarization light beam goes into the second right-angle reflector 13b with reflection twice, and then normally goes through the second polarization control crystal 14b to lead all wave polarization rotated and have an angle θ2 being related to the optic-axis of the birefringent crystal 11. Therefore, all light with different wavelengths go through the birefringent crystal 11 at 45° orientation once to achieve fundamental filtering effect. Moreover, the light goes through the birefringent crystal 11 at θ2 orientation forward and backward (satisfied with L2=2L1) each to gain a flattened filtering light beam 140. Conclusively, this invention only used a birefringent crystal 11, therefore there is no filtering spectrum error caused by unmatched length problem.

### SECOND EXAMPLE

### Temperature Stable Birefringent Filter Configuration

According to the configuration of this invented stable temperature birefringent filter is shown in FIG. 5b, In order to gain the correction and compensation to the temperature variation, it adds a temperature stable birefringent crystal 12 into the example 1. The optic forward path is determined as the horizontal incident light beam 110 (λ1, λ2, λ3, λ4, . . . ) with a polarization angle is 45 degree to the optic axis of the birefringent crystal 11, and then passes in front of the birefringent crystal 11 and goes normally through the birefringent crystal 11. Furthermore, the light beam passing through the birefringent crystal 11 will cause an orthogonal polarization between the odd wavelength (λ1, λ3, λ5, . . . ) and the even wavelength (λ2, λ4, λ6, . . . ) is due to the phase-delay of different wavelengths. The orthogonal polarization light beam now goes into the temperature stable birefringent crystal 12, which is formed on a surface of the birefringent crystal 11. It performs stable temperature and compensation functions (corrects the deviation due to the temperature variation). Its optic axis is defined as same as the birefringent crystal 11, but material is different from the birefringent crystal 11. The birefringent crystal 11 can be made of YV04 crystal and the temperature stable birefringent crystal 12 is made of LiNb03. When the light beam goes through the first polarization control crystal 14a to form first reflect light beam 120 (reverse orientation to original incident light) after reflection twice inside the first right-angle reflector 13a. Herein all wave polarization will be rotated with an angle θ2 being related to the optic-axis as soon as the light beam went through the first polarization control crystal 14a. Recursively adopts right-angle reflector to exchange the light-beam forwarding path, that first reflect light beam 120 will go through birefringent crystal 11 and temperature stable birefringent crystal 12, and then make that first reflect light beam 120 reflect twice inside the second right angle reflector 13b to form a second reflect light beam 130 (same orientation to original incident light) after it pass through the second polarization control crystal 14b. After all that second reflect light beam 130 will normally pass through birefringent crystal 11 and temperature stable birefringent crystal 12 to form a flattened filtering light beam 140. Herein the orthogonal polarization light beam goes into the second right-angle reflector 13b with reflection twice, and then normally goes through the second polarization control crystal 14b to lead all wave polarization rotated and have an angle θ2 being related to the optic-axis of the birefringent crystal 11. Therefore, all light with different wavelengths go through birefringent crystal 11 and temperature stable birefringent crystal 12 at 45° orientation once to achieve a fundamental filtering and the stable temperature correction effects. Moreover, the light travels forward and backward through the birefringent crystal 11 at θ2 orientation (satisfied with L2=2L1) to gain a flattened filtering light beam 140. Because this invention only used a birefringent crystal 11, there is no filtering spectrum error caused by unmatched length problem.

### THIRD EXAMPLE

### Schematic Drawing of this Invented High Filtering Precision Optical Signal Interleaver

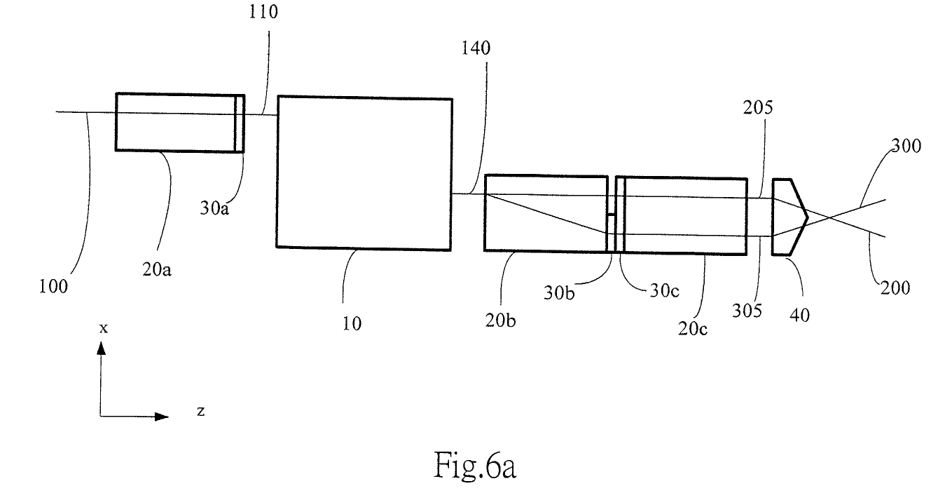

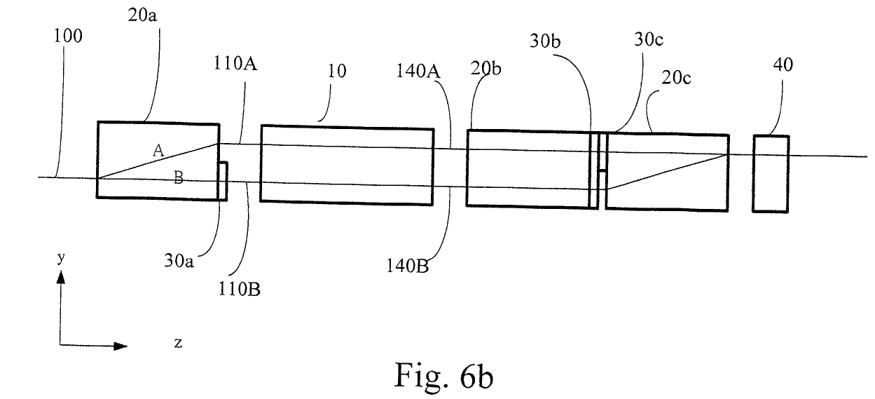

As shown in FIG. 6a and FIG. 6b, both X-Z and Y-Z planar schematic of this invented optical signal high filtering precision optical signal interleaver are presented.

The structure comprises: first polarization splitter 20a, a birefringent filter 10, a polarization rotary mechanism 40, second polarization splitter 20b, third polarization splitter 20c and an optic angle refractor 50. Wherein the birefringent filter 10 structure showed in FIG. 5a and FIG. 5b. The optic forward path is output from a output light of single-core collimator 110 (λ1, λ2, λ3, λ4, . . . ) 100, and then it goes through first polarization splitter 20a and first polarization rotary mechanism 30a that only affect the lower light beam of the Y-Z plan. Dividing the output light of single-core collimator 100 into upper incident light beam 110A and lower incident light beam 110B. Only the lower incident light beam 110B is allowed to pass through first polarization rotary mechanism 30a, please see FIG. 6b, and then both the upper incident light beam 110A and the lower incident light beam 110B go together into the birefringent filter 10 and a polarization rotary mechanism 40 to acquire two flattened filtering light beam 140 (upper flattened filtering light beam 140A and lower flattened filtering light beam 140B). Furthermore, the odd and even wavelengths will be separated by second polarization 20b. The separated light beams with odd and even wavelength go through second polarization rotary crystal 30b and third polarization rotary crystal 30c, and then couple them respectively by using third polarization splitter 20c. Finally they will exchange their orientation by using optic angle refractor and individually couple into the two ports of a dual-core collimator. Herein the first polarization splitter 20a, the second polarization splitter 20b and the third polarization splitter 20c can be made of a birefringent crystal, moreover it can be added a Farad ay Crystal or a λ/2 polarization rotary crystal on its polarization separator.

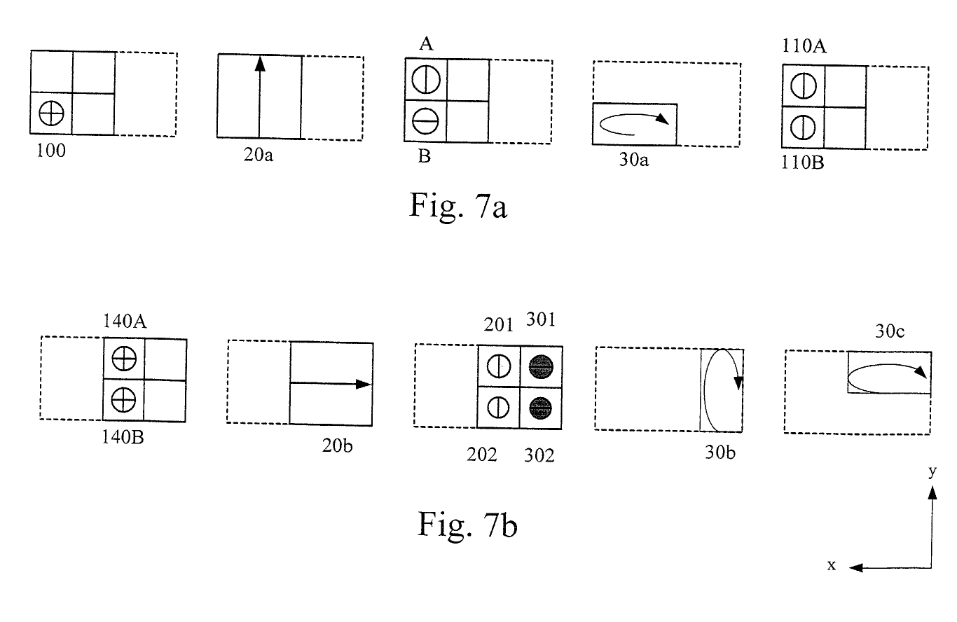

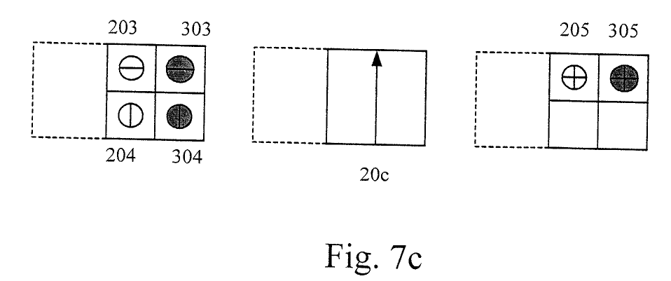

The principle of FIG. 6 can be explained with FIG. 7a-FIG. 7c, and FIG. 7a˜FIG. 7c are the schematic drawing of optical signal polarization state that is corresponding to the separated wave of each element in FIG. 6. As shown in FIG. 7a, the output light of single-core collimator 100, which owns whole signal wavelength, incoming to the first polarization splitter 20a at a walk-off direction as y-axis, and then it will be separated into O-ray (Ordinary-ray) B and E-ray (Extraordinary-ray) A. Moreover B goes through first polarization rotary crystal 30a and is polarized to rotate 90° becoming upper incident light beam 110A and lower incident light beam 110B. Both light beams are in the same polarization state (optical signal own whole wavelength). As shown in FIG. 7b, upper incident light beam 110A and lower incident light beam 110B go through birefringent filter 10, and then odd wavelength (λ1, λ3, λ5, . . . ) light's polarization will not be changed but even wavelength (λ2, λ4, λ6, . . . ) light's polarization will be rotated 90° (compared to 110A and 110B). Therefore, Upper flattened filtering light beam 140A and lower flattened filtering light beam 140B have two polarization states related to the orthogonal wavelength. After they pass through the second polarization splitter 20b, they will separated into four light beams as odd wavelength light beam (201, 202) and right-hand side walk-off's even wavelength light beam (301, 302) respectively. 301 and 302 will go through second polarization rotary crystal 30b and rotated 90°, but 201 and 301 will go through third polarization rotary crystal 30c again and then rotated 90°, as shown in FIG. c. (203, 204) and (303, 304) are orthogonal intercrossing individually, and then merged to form 205 (odd wavelength signal) and 305 (even wavelength signal) after they go through third polarization splitter 20c. Finally, 205 and 305 will go through an optic angle refractor 50, under traveling orientation changed, to produce light beam 200 and light beam 300 separately, and then coupling them into a dual-core collimator.

What is claimed is:

1. A structure of high filtering precision optical signal interleaver which comprises:
(A) first polarization splitter;
(B) a birefringent filter, which is located behind the first polarization splitter and comprises;
(a) a birefringent crystal which is rectangular configuration;
(b) first right-angle reflector, which is located behind the birefringent crystal;
(c) first polarization control crystal, which is located between the first right-angle reflector and the birefringent crystal, and used only for the reflect light after it pass through the first right-angle reflector;
(d) second right-angle reflector, which is located in front of the birefringent crystal; and
(e) second polarization control crystal, which located between the second right-angle reflector and the birefringent crystal, and used only for the reflect light after it pass through the second right-angle reflector;
Whenever a horizontal incident light (optical signal owns whole related wavelength) passes through the birefringent crystal, it will generate the orthogonal polarization between the odd and even wavelengths. Herein the optic forward path is determined as the incident light passing in front of the birefringent crystal and horizontally through the birefringent crystal. After its reflection twice inside the first right-angle reflector, then it goes through the first polarization control crystal and birefringent crystal in the reverse parallel direction to the original incident light path. That light beam will reflect twice inside the second right-angle reflector to form a light beam in the same direction to the original incident light path, and then goes through the second polarization control crystal and birefringent crystal. Conclusively, a structure of high filtering precision optical signal interleaver is formed.
(C) polarization rotary mechanism, which is located behind the birefringent filter;
(D) second polarization splitter, which is located behind the polarization rotary mechanism;
(E) third polarization splitter, which is linked behind the second polarization splitter; and
(F) optic angle refractor, which is located behind the third polarization splitter;
Integrates all of the above items, the structure of high filtering precision optical signal interleaveris formed.

2. A structure of high filtering precision optical signal interleaver, which comprises of claim 1, wherein the birefringent crystal's material can be YV04, and the angle between the horizontal incident light and the birefringent crystal's optic axis is 45 degree.

3. A structure of high filtering precision optical signal interleaver, which comprises of claim 1, wherein first right-angle reflector and second right-angle reflector of the birefringent filter are a right-angle prism, and the reflection twice leads to generate a reversely parallel light to its original light after it goes through right-angle reflector.

4. A structure of high filtering precision optical signal interleaver, which comprises of claim 1, wherein first polarization control crystal and second polarization control crystal of the birefringent filter are half-wave plates.

5. A structure of high filtering precision optical signal interleaver, which comprises of claim 1, wherein the optic angle refractor can be an optical glass or a glass with high refract index.

6. A structure of high filtering precision optical signal interleaver, which comprises of claim 1 wherein first polarization splitter, second polarization splitter and third polarization splitter can be a birefringent crystal, and it can also be added a Faraday crystal or a λ/2 polarization crystal on these polarization splitter.

7. A structure of high filtering precision optical signal interleaver, which comprises of:
(A) first polarization splitter;
(B) a birefringent filter, which is located behind the first polarization splitter and comprises:
(a) a birefringent crystal, which is rectangular configuration;
(b) a temperature stable birefringent crystal, which is formed on a surface of the birefringent crystal;
(c) first right-angle reflector, which is located behind the birefringent crystal;
(d) first polarization control crystal, which is located between the first right-angle reflector and the birefringent crystal, and used only for the reflect light after it pass through the first right-angle reflector;
(e) second right-angle reflector, which is located in front of the birefringent crystal; and
(f) second polarization control crystal, which located between the second right-angle reflector and the birefringent crystal, and used only for the reflect light after it pass through the second right-angle reflector;
Whenever a horizontal incident light (optical signal owns whole related wavelength) passes through the birefringent crystal and a temperature stable birefringent crystal, and then device forms the orthogonal polarization between the odd and even wavelengths. The main function of this temperature stable birefringent crystal is to make the temperature stable and correct the error. Herein the optic forwarding path is determined as the incident light passing in front of birefringent crystal and horizontally through the birefringent crystal and temperature stable birefringent crystal. After its reflection twice inside the first right-angle reflector, then it goes through the first polarization control crystal, temperature stable birefringent crystal and birefringent crystal in the reverse parallel direction to the original incident light path. That light beam will reflect twice inside the second right-angle reflector to form a light beam in the same direction to the original incident light path, and then goes through the second polarization control crystal, the temperature stable birefringent crystal and the birefringent crystal. Conclusively, a structure of high filtering precision optical signal interleaver is formed.
(C) polarization rotary mechanism, which is located behind the birefringent filter;
(D) second polarization splitter, which is located behind the polarization rotary mechanism;
(E) third polarization splitter, which is linked behind the second polarization splitter; and
(F) a optic angle refractor, which is located behind the third polarization splitter;
Integrates all of the above items, the structure of high filtering precision optical signal interleaver is formed.

8. A structure of high filtering precision optical signal interleaver, which comprises of claim 7, wherein the birefringent crystal's material can be YV04, and the angle between the horizontal incident light and the birefringent crystal's optic axis is 45 degree.

9. A structure of high filtering precision optical signal interleaver, which comprises of claim 7, wherein first right-angle reflector and second right-angle reflector of the birefringent filter are a right-angle prism cylinder, and the reflection twice leads to generate a reversely parallel light to its original light after it goes through right-angle reflector.

10. A structure of high filtering precision optical signal interleaver, which comprises of claim 7, wherein first polarization control crystal and second polarization control crystal of the birefringent filter are half-wave plates.

11. A structure of high filtering precision optical signal interleaver, which comprise of claim 7, wherein the temperature stable birefringent crystal material of the birefringent filter can be LiNb03, and owns a similar optic-axis angle as the birefringent filter did.

12. A structure of high filtering precision optical signal interleaver, which comprises of claim 7, wherein the optic angle refractor can be an optic glass or a glass with high refract index.

13. A structure of high filtering precision optical signal interleaver, which comprises of claim 7, wherein the first polarization splitter, the second polarization splitter and the third polarization splitter can be a birefringent crystal, and it can also be added a Faraday crystal or a λ/2 polarization crystal on the polarization splitter.
